(19) United States
(12) Patent Application Publication
(10) Pub. No.: US 2026/0227573 A1
(43) Pub. Date: Aug. 6, 2026

(54) CAPILLARY TUBE END FACE PROCESSING TO REDUCE HEATING OF FIBER OPTIC COMBINERS

(71) Applicant: Lumentum Operations LLC, San Jose, CA (US)

(72) Inventors: Matthew KUTSURIS, Dublin, CA (US); Vincent PETIT, Cupertino, CA (US); Gongwen ZHU, San Jose, CA (US)

(21) Appl. No.: 19/096,162

(22) Filed: Mar. 31, 2025

Related U.S. Application Data
(60) Provisional application No. 63/753,004, filed on Feb. 3, 2025.

(51) Int. Cl. G02B 6/28

(52) U.S. Cl. CPC G02B 6/2817

(57) ABSTRACT

A light combiner assembly includes a plurality of fibers that have respective unstripped sections and respective stripped sections and form a fiber bundle, the plurality of fibers configured to receive light from respective light sources and combine the light into forward propagating light; and a capillary tube that includes a tube body that defines an internal tube volume in which the plurality of fibers is arranged. The tube body includes a non-tapered section, including a first end face arranged proximate to the respective unstripped sections, and a tapered section, including a second end face, arranged around the respective stripped sections and to which the respective stripped sections are fused. The tapered section tapers from a first outer tube diameter to a second outer tube diameter. Additionally, the first end face is configured to direct backward propagating light away from the respective unstripped sections.

### CROSS-REFERENCE TO RELATED APPLICATION

This Patent application claims priority to U.S. Provisional Patent Application No. 63/753,004, filed on Feb. 3, 2025, and entitled “CAPILLARY TUBE END FACE PROCESSING TO REDUCE HEATING OF FIBER OPTIC COMBINERS.” The disclosure of the prior Application is considered part of and is incorporated by reference into this Patent Application.

### TECHNICAL FIELD

The present disclosure relates generally to fiber optic combiners and to fiber optic combiners with reduced heating

### BACKGROUND

Scaling the output power of lasers can be accomplished by increasing pump power. In the case of a fiber laser or a free space laser for continuous wave or pulsed laser applications, pumps may be combined using fiber combiners. Depending on the type of laser and laser architecture, several types of combiners can be used, including pump combiners and pump-signal combiners, to inject pump light into an optical fiber. In the case of a kilowatt (kW) fiber laser, combiners can be used for forward pumping and/or backward pumping. Another approach to scale the output power of lasers involves combining multiple lasers together using signal combiners.

### SUMMARY

In some implementations, a light combiner assembly includes a plurality of fibers that form a fiber bundle, wherein the plurality of fibers have respective unstripped sections and respective stripped sections, and wherein the plurality of fibers are configured to receive light from a plurality of respective light sources and combine the light into forward propagating light; and a capillary tube that includes a tube body that defines an internal tube volume in which the plurality of fibers is arranged, wherein the tube body includes a non-tapered section, including a first end face arranged proximate to the respective unstripped sections, and a tapered section, including a second end face, arranged around the respective stripped sections and to which the respective stripped sections are fused, wherein the tapered section tapers from a first outer tube diameter of the first end face to a second outer tube diameter of the second end face, and wherein the first end face is configured to direct backward propagating light away from the respective unstripped sections.

In some implementations, a method of manufacturing a light combiner assembly includes providing a capillary tube that includes a tube body that defines an internal tube volume, wherein the tube body includes a non-tapered section, including a first end face, and a tapered section, including a second end face, wherein the first end face and the second end face are opposite longitudinal ends of the tube body that extend between an outer surface of the tube body and an inner surface of the tube body, wherein the tapered section tapers from a first outer tube diameter defined by the first end face to a second outer tube diameter defined by the second end face, and wherein the first end face is configured to direct backward propagating light in one or more directions; inserting a fiber bundle, comprising a plurality of fibers, into the internal tube volume, wherein the plurality of fibers have respective unstripped sections and respective stripped sections; and fusing the respective stripped sections to the tapered section of the capillary tube, wherein the one or more directions are directed away from the respective unstripped sections.

### BRIEF DESCRIPTION OF THE DRAWINGS

FIG. 1A shows a cross-section of a light combiner assembly taken along a longitudinal axis according to one or more implementations.

FIG. 1B shows a light combiner assembly according to one or more implementations.

FIG. 1C shows forward and backward light propagation in a light combiner assembly according to one or more implementations.

FIG. 2 shows a light combiner assembly according to one or more implementations.

FIG. 3 shows a light combiner assembly according to one or more implementations.

FIG. 4 is a flowchart of an example process for manufacturing a light combiner assembly.

### DETAILED DESCRIPTION

The following detailed description of example implementations refers to the accompanying drawings. The same reference numbers in different drawings may identify the same or similar elements.

Challenges in designing components of a laser system may be independent of the type(s) of combiner being used. For example, because multiple fibers from multiple laser diodes or from different laser diodes are coupled to one output fiber, challenges arise in connection with packing fibers while maintaining the quality of a beam at an output of a combiner. The optical quality of a beam at an output of a combiner is mostly related to the brightness, and thus the numerical aperture (NA), of light exiting the combiner. The brightness of a combiner may be affected by the manner in which fibers from the laser diodes are packed together.

To control brightness while minimizing losses, fibers from the laser diodes may be packed together, fused, and then tapered down. A tapered end of the combiner may be spliced to an output fiber. The process of packing the fibers should be predictable and repeatable to achieve consistent combiner manufacturing. Accordingly, glass capillary tubes may be used to hold the fibers together. Thus, the fibers from the laser diodes may be bundled together and inserted inside a capillary tube that will preserve the shape of the bundle. The fibers may be stripped over a certain length prior to being inserted in the capillary tube. The stripped fibers may be fused with the capillary tube, which is then tapered down to match the dimensions of the output fiber.

Using a fiber combiner preserves brightness, but may allow any backward light from the laser to propagate back, causing reliability issues. The backward light may be any unwanted light that propagates backward through the capillary tube, and may include reflected light or light generated from another source. For example, unwanted backward propagating light may include pump light, signal light, laser light, backward reflection light, backward scattered light, amplified light, an amplified spontaneous emission (ASE), a stimulated Raman scattering (SRS), and/or a stimulated Brillouin scattering (SBS). Fiber combiners for kW fiber lasers typically use capillary tubes to help pack and fuse fibers together into an input fiber bundle. Capillary tubes are typically glass with flat end faces that encompass the input fiber bundle. Unwanted backward-propagating light (e.g., back reflection, amplified stimulated emission, residual pump in bi-directional pump scheme, etc.) coming from low divergence may be guided by the capillary tube (e.g., by a tube body of the capillary tube) in a backward-propagating direction and may exit at a capillary tube end face. The backward-propagating light that exits the capillary tube end face may hit and be absorbed by the input fiber bundle, causing fiber heating, fiber burn, and/or other damage. Thus, in such a case, the capillary tube used in the fiber combiner may act as a waveguide. Light propagating back in the capillary tube may generate unwanted heating. Moreover, if backward-propagating light is guided in the capillary tube, the light may exit at an end of the tube and interact with the input bundled fibers, which may burn or damage the fiber coatings of the input fibers. For example, if backward light guided in the capillary tube reaches unstripped portions of the fibers, the backward light may interact with the fibers, which may burn or damage the fiber coatings of the unstripped portions of the fibers.

In some cases, an outermost surface of the capillary tube may be etched or structured to force light to escape the capillary tube. Such external stripping methods may enable the stripping of high-NA light. However, light with a lower NA that does not interact with the outermost surface of the capillary tube as much as high-NA light may not be stripped using a conventional cladding light stripper. Thus, such external stripping methods are ineffective at stripping backward light to prevent damage to the fiber coatings of the unstripped portions of the fibers. Moreover, a conventional cladding light stripper may provide insufficient light stripping for some capillary tubes, such as silica tubes with fluorine-doped silica on an inner surface.

Some implementations described herein may include a light combiner assembly that includes a plurality of fibers that have respective unstripped sections and respective stripped sections and form a fiber bundle. The plurality of fibers may be configured to receive light from respective light sources and combine the light into forward propagating light. The light combiner assembly may further include a capillary tube that includes a tube body that defines an internal tube volume in which the plurality of fibers is arranged. The tube body may include a non-tapered section, including a first end face arranged proximate to the respective unstripped sections. The tube body may include a non-tapered section may include a tapered section, including a second end face, arranged around the respective stripped sections and to which the respective stripped sections are fused. The tapered section may taper from a first outer tube diameter (e.g., a tube diameter of the first end face) to a second outer tube diameter (e.g., a tube diameter of the second end face). Additionally, the first end face may be configured to direct backward propagating light away from the respective unstripped sections in order to protect the respective unstripped sections from heating and damage.

In some implementations, the second end face is coupled to an output fiber that is configured to receive the forward propagating light from the plurality of fibers (e.g., from the fiber bundle). In addition, the backward propagating light may enter the capillary tube from the output fiber. Thus, the output fiber may provide the backward propagating light to the capillary tube.

Some implementations described herein may include a reflective element on a capillary tube end face to reflect backward-propagating light from a backward-propagating direction into a forward-propagating direction. The reflective element may prevent the backward-propagating light from exiting the capillary tube end face where the backward-propagating light may otherwise come into contact with fiber coatings of the input fibers and cause burns. Thus, the reflective element may be disposed on the capillary tube end face so that the backward-propagating light reflects through the capillary tube and away from input bundle fibers. The reflective element may be formed on the capillary tube end face by chemical vapor deposition to create a thin film optical coating that can achieve greater than 99% reflectivity. Thus, the reflective element may be a high reflective (HR) element.

Some implementations described herein may include a capillary tube end face designed as an angled end face that extends at an angle configured to deflect backward-propagating light via total internal reflection. In other words, the capillary tube end face of a capillary tube may be angled and polished in such a way that backward-propagating light impinging on the capillary tube end face is deflected away from fiber coatings of the input fibers. In some implementations, sandpaper, starting with low grit and gradually increasing to high grit (grit-1000 or more), may be used to create the angle and polish the angled end face. In some implementations, laser ablation may be used to create the angle and polish the angled end face.

Some implementations described herein may include a capillary tube end face designed as an angled end face, with a roughened surface, configured to diffuse or scatter backward-propagating light away from input bundle fibers. In some implementations, the angled end face, with the roughened surface, may be formed by mechanical shaping and polishing. In some implementations, the angled end face, with the roughened surface, may be formed by applying an acid etch cream on an angled end face for 5-10 minutes to create a diffuse surface, then cleaning the roughened surface with a solvent to stop the etching.

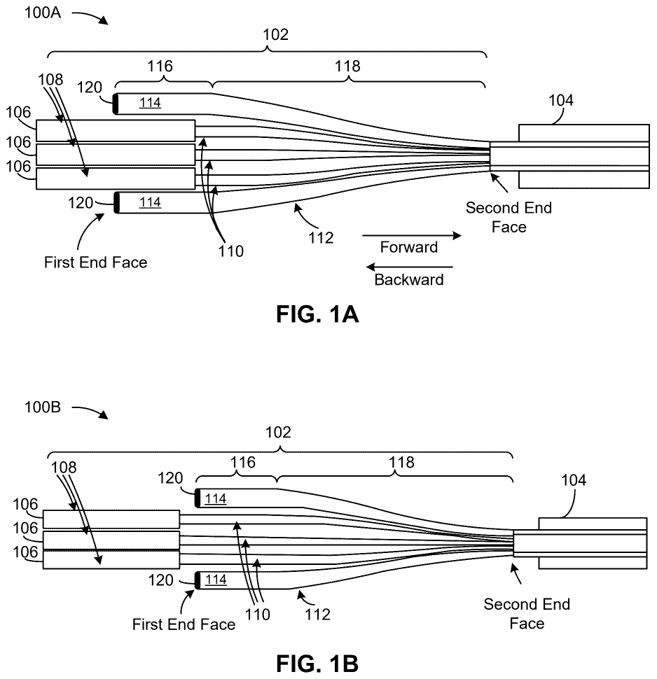

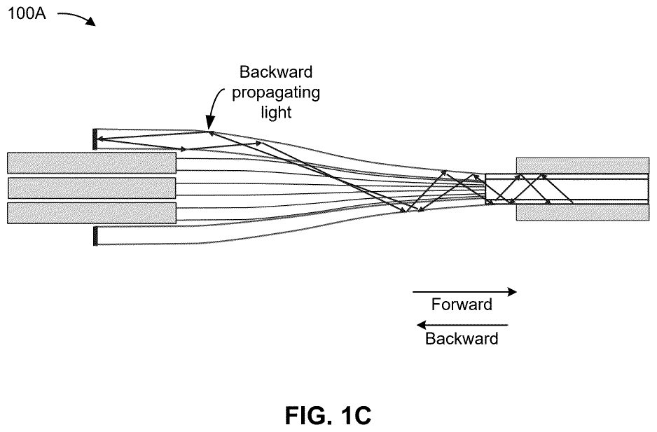

FIG. 1A shows a cross-section of a light combiner assembly 100A taken along a longitudinal axis according to one or more implementations. The light combiner assembly 100A may include a combiner 102 and an output fiber 104 that is spliced to the combiner 102 for receiving forward propagating light traveling in a forward propagating direction (e.g., from left-to-right). In addition, the combiner 102 may receive backward propagating light from the output fiber 104 that travels in a backward propagating direction (e.g., from right-to-left). The combiner 102 may be a signal combiner.

The combiner 102 may include a plurality of fibers 106 that form a fiber bundle. The plurality of fibers may have respective unstripped sections 108 and respective stripped sections 110. Additionally, the plurality of fibers 106 are configured to receive light from a plurality of respective light sources and combine the light into the forward propagating light.

The combiner 102 may include a capillary tube 112 that includes a tube body 114 that defines an internal tube volume in which the plurality of fibers 106 is arranged. The tube body 114 may include a non-tapered section 116, including a first end face (e.g., a first longitudinal end) arranged proximate to the respective unstripped sections 108. The tube body 114 may also include a tapered section 118, including a second end face (e.g., a second longitudinal end). The first end face and the second end face are opposite longitudinal ends of the tube body 114 that extend between an outer surface of the tube body 114 and an inner surface of the tube body 114.

The tapered section 118 may be arranged around the respective stripped sections 110. The respective stripped sections 110 may be fused to the tapered section 118. The tapered section 118 may taper from a first outer tube diameter of the non-tapered section 116 to a second outer tube diameter of the second end face such that the second tube diameter matches or substantially matches a diameter of the output fiber 104. The first outer tube diameter may correspond to an outer diameter of the first end face.

The second end face may be spliced to the output fiber 104. In some implementations, instead of being spliced to the output fiber 104, the second end face may be spliced to a second capillary tube spliced to the second end face for providing the forward propagating light to the second capillary tube. An end of the second capillary tube opposite to the capillary tube 112 may be spliced to the output fiber 104.

In some examples, the plurality of fibers 106 may be inserted into the internal tube volume such that the respective unstripped sections 108 are arranged inside the internal tube volume. Thus, the non-tapered section 116 may be arranged around the respective unstripped sections 108. In other examples, the plurality of fibers 106 may be inserted into the internal tube volume such that the respective unstripped sections 108 remain outside of the internal tube volume.

The first end face is configured to direct backward propagating light away from the respective unstripped sections. For example, a high-reflective element 120 may be arranged on the first end face. The high-reflective element 120 is configured to reflect the backward propagating light away from the respective unstripped sections 108. The high-reflective element 120 may reflect the backward propagating light into the forward propagating direction. As a result, a significant portion (e.g., at least 90%) of backward propagating light does not interact with the respective unstripped sections 108, thereby reducing heating of the respective unstripped sections 108 that may cause damage to the respective unstripped sections 108. The high-reflective element 120 is positioned to reflect both high NA backward propagating light and low NA backward propagating light away from the respective unstripped sections 108. Thus, the high-reflective element 120 redirects any backward propagating light that is incident on the first end face.

In some cases, at least 95% of the backward propagating light does not interact with the respective unstripped sections 108 as a result of the high-reflective element 120 being arranged at the first end face. In some cases, at least 99% of the backward propagating light does not interact with the respective unstripped sections 108 as a result of the high-reflective element 120 being arranged at the first end face. In some implementations, the high-reflective element 120 is a high-reflective coating configured to reflect at least 99% of light incident on the high-reflective element 120. For example, the high-reflective element 120 may be formed on the capillary tube end face by chemical vapor deposition to create a thin film optical coating that can achieve greater than 99% reflectivity.

In view of the above, light combiner assembly 100A has a capillary tube 112 that has a capillary tube end face designed to direct backward-propagating light away from a fiber bundle, removing unwanted heat from a combiner and preventing damage to the fibers 106 of the fiber bundle.

As indicated above, FIG. 1A is provided as an example. Other examples may differ from what is described with regard to FIG. 1A.

FIG. 1B shows a light combiner assembly 100B according to one or more implementations. The light combiner assembly 100B may be similar to the light combiner assembly 100A described in connection with FIG. 1A, except that the respective unstripped sections 108 are arranged outside of the capillary tube 112. The high-reflective element 120 is configured to reduce an amount of the backward propagating light that reaches the respective unstripped sections 108.

As indicated above, FIG. 1B is provided as an example. Other examples may differ from what is described with regard to FIG. 1B.

FIG. 1C shows forward and backward light propagation in the light combiner assembly 100A according to one or more implementations.

As indicated above, FIG. 1C is provided as an example. Other examples may differ from what is described with regard to FIG. 1C.

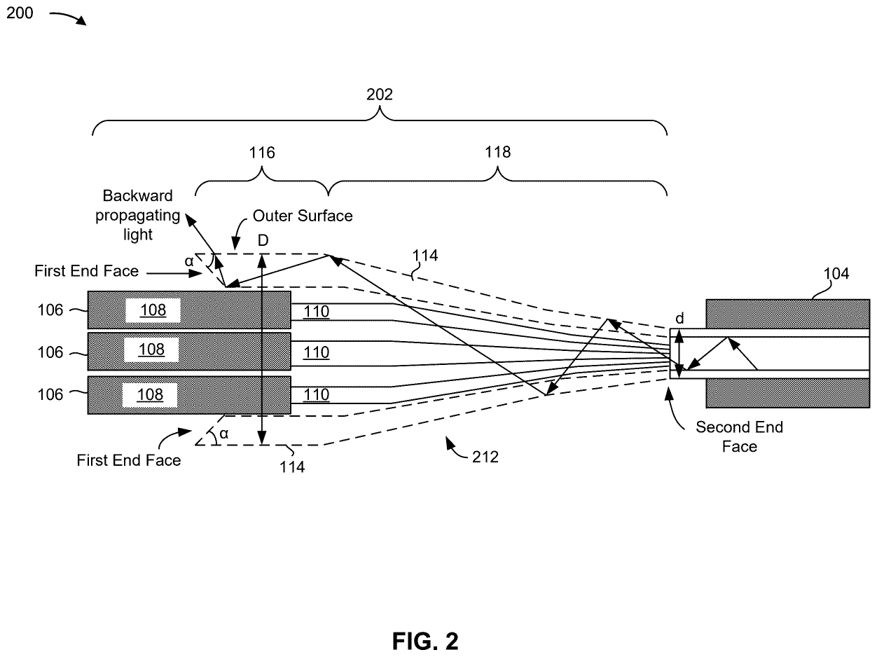

FIG. 2 shows a light combiner assembly 200 according to one or more implementations. The light combiner assembly 200 may be similar to the light combiner assembly 100A described in connection with FIG. 1A, except capillary tube 212 replaces capillary tube 112. Thus, the light combiner assembly 200 includes a combiner 202 that is similar to the combiner 102, with similar parts described in connection with FIG. 1A.

A first end face of the capillary tube 212 is an angled end face configured to internally reflect the backward propagating light such that the backward propagating light is directed away from the plurality of fibers 106 (e.g., away from the respective unstripped sections 108). The first end face is angled away from the second end face. Thus, the first end face of the capillary tube 212 reduces an amount of the backward propagating light that reaches the respective unstripped sections 108.

In some implementations, the first end face has a specularly smooth surface to cause an internal reflection of the backward propagating light away from the plurality of fibers 106. The internal reflection may be a specular reflection at a predefined angle.

In some implementations, the first end face has a polished surface configured to prevent the backward propagating light from scattering in unwanted directions. Backward propagating light that scatters in unwanted directions may not be properly deflected away from the plurality of fibers 106 (e.g., from the respective unstripped sections 108). Thus, the polished surface may prevent scattering to ensure that a significant portion of backward propagating light is internally reflected at the predefined angle.

The tapered section 118 may taper from a first outer tube diameter (e.g., a tube diameter of the first end face) to a second outer tube diameter (e.g., a tube diameter of the second end face). An outer surface of the tube body 114 and the first end face may be coupled at an angle α defined by an expression of the form:

$$α \leq {cos}^{- 1} ( \frac{1}{n} ) - \frac{N A * d}{D * n}$$

Here, n represents a refractive index of the tube body 114, NA represents a maximum numerical aperture associated with the backward propagating light, D represents the first outer tube diameter, and d represents the second outer tube diameter. The angle α is configured to cause an internal reflection of the backward propagating light such that the backward propagating light incident on the first end face is directed away from the plurality of fibers 106 (e.g., from the respective unstripped sections 108). Thus, the outer surface of the tube body 114 and the first end face may be coupled at an angle α that is based on a ratio of the second outer tube diameter and the first outer tube diameter. Additionally, or alternatively, the outer surface of the tube body 114 and the first end face may be coupled at an angle α that is based on a ratio of a maximum numerical aperture NA and a refractive index of the tube body. The maximum numerical aperture may be a known value associated with the backward propagating light.

In some implementations, sandpaper, starting with low grit and gradually increasing to high grit (grit-1000 or more), may be used to create the angle α and polish the angled end face. In some implementations, laser ablation may be used to create the angle α and polish the angled end face. For example, a system for manufacturing the capillary tube 212 may include a cone of sandpaper that is inserted into an internal tube volume of the capillary tube 212 at the first end face, and rotated to form the angled end face having an angle α that causes backward propagating light to be internally reflected at the predefined angle away from the internal tube volume of the capillary tube 212.

In view of the above, light combiner assembly 200 has a capillary tube 212 that has a capillary tube end face designed to direct backward-propagating light away from a fiber bundle, removing unwanted heat from a combiner and preventing damage to the fibers 106 of the fiber bundle.

As indicated above, FIG. 2 is provided as an example. Other examples may differ from what is described with regard to FIG. 2.

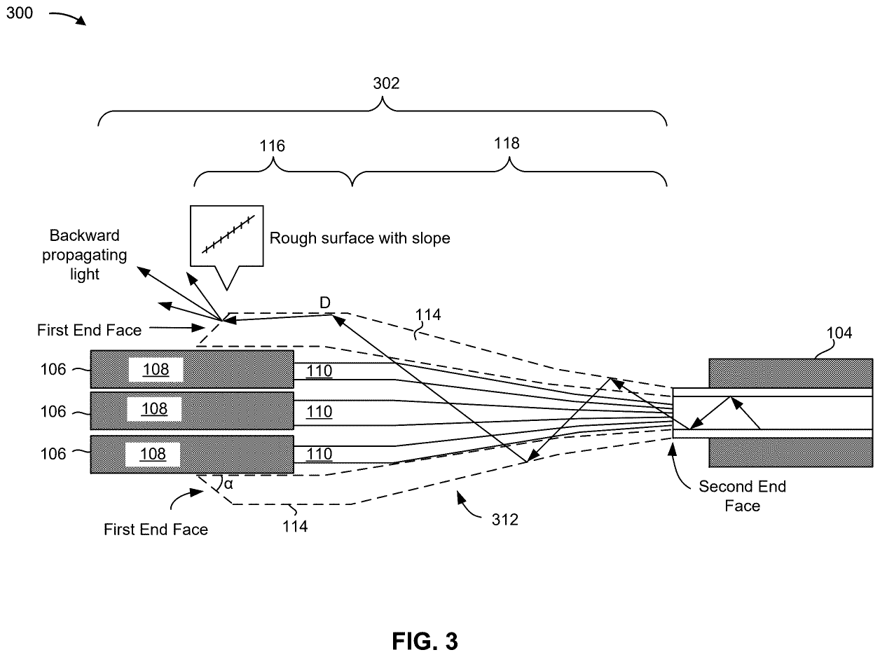

FIG. 3 shows a light combiner assembly 300 according to one or more implementations. The light combiner assembly 300 may be similar to the light combiner assembly 100A described in connection with FIG. 1A, except capillary tube 312 replaces capillary tube 112. Thus, the light combiner assembly 300 includes a combiner 302 that is similar to the combiner 102, with similar parts described in connection with FIG. 1A.

A first end face of the capillary tube 312 is an angled end face configured to diffuse backward propagating light such that the backward propagating light is directed away from the plurality of fibers 106. The first end face has a rough surface (e.g., a diffusion surface) that is configured to cause a diffuse reflection of the backward propagating light. The first end face is angled toward the second end face. Accordingly, the first end face of the capillary tube 212 reduces an amount of the backward propagating light that reaches the respective unstripped sections 108. An angle α of the first end face relative to an inner surface of the tube body 114 may be between 20 degrees and 45 degrees in order to maximize an amount of backward propagating light that is directed away from the respective unstripped sections 108.

In some implementations, the angled end face, with a roughened surface, may be formed by mechanical shaping and polishing. In some implementations, the angled end face, with the roughened surface, may be formed by applying an acid etch cream on an angled end face for 5-10 minutes to create a diffuse surface, then cleaning the roughened surface with a solvent to stop the etching. The roughened surface forms a scattering element, and an angle of the angled end face forces the backward-propagating light away from an input fiber bundle via scattering.

In view of the above, light combiner assembly 300 has a capillary tube 312 that has a capillary tube end face designed to direct backward-propagating light away from a fiber bundle, removing unwanted heat from a combiner and preventing damage to the fibers 106 of the fiber bundle.

As indicated above, FIG. 3 is provided as an example. Other examples may differ from what is described with regard to FIG. 3.

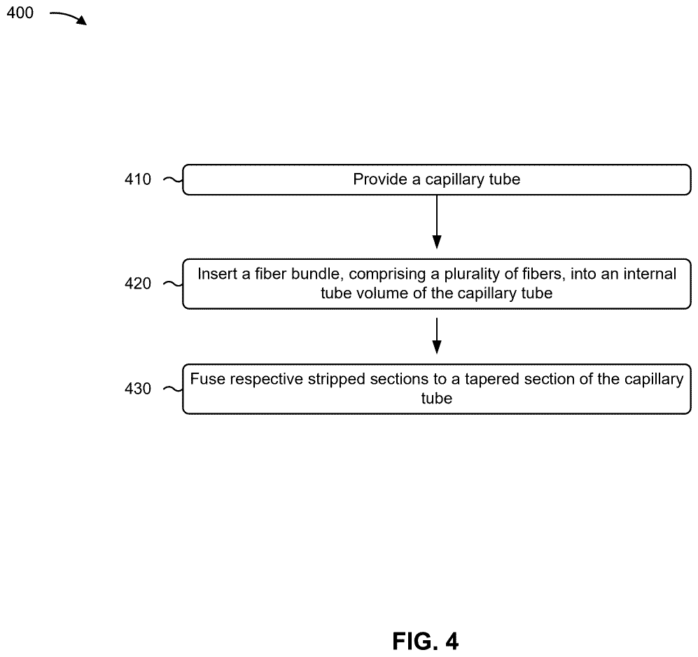

FIG. 4 is a flowchart of an example process 400 for manufacturing a light combiner assembly. The process 400 may be associated with capillary tube end face processing to reduce heating of fiber optic combiners. One or more process blocks of FIG. 4 are performed by a manufacturing system configured to manufacture a combiner and/or a light combiner assembly. The manufacturing system may manufacture a combiner and/or a light combiner assembly in accordance with method described elsewhere herein.

As shown in FIG. 4, process 400 includes providing a capillary tube (block 410). The capillary tube includes a tube body that defines an internal tube volume, wherein the tube body includes a non-tapered section, including a first end face, and a tapered section, including a second end face, wherein the first end face and the second end face are opposite longitudinal ends of the tube body that extend between an outer surface of the tube body and an inner surface of the tube body. The tapered section may taper from a first outer tube diameter defined by the first end face to a second outer tube diameter defined by the second end face. Additionally, the first end face is configured to direct backward propagating light in one or more directions

As further shown in FIG. 4, process 400 includes inserting a fiber bundle, comprising a plurality of fibers, into the internal tube volume (block 420). The plurality of fibers have respective unstripped sections and respective stripped sections

As further shown in FIG. 4, process 400 includes fusing the respective stripped sections to the tapered section of the capillary tube (block 430). The capillary tube is manufactured such that the one or more directions are directed away from the respective unstripped sections.

Process 400 may include additional aspects, such as any single aspect or any combination of aspects described below and/or in connection with one or more other processes described elsewhere herein.

In a first aspect, process 400 includes providing a high-reflective element on the first end face, wherein the high-reflective element is configured to reflect the backward propagating light away from the respective unstripped sections.

In a second aspect, process 400 includes forming the first end face as an angled end face that is configured to internally reflect the backward propagating light such that the backward propagating light is directed away from the plurality of fibers.

In a third aspect, process 400 includes forming the first end face as an angled end face that is configured to diffuse the backward propagating light such that the backward propagating light is directed away from the plurality of fibers.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

The following provides an overview of some Aspects of the present disclosure:

Aspect 1: A light combiner assembly, comprising: a plurality of fibers that form a fiber bundle, wherein the plurality of fibers have respective unstripped sections and respective stripped sections, and wherein the plurality of fibers are configured to receive light from a plurality of respective light sources and combine the light into forward propagating light; and a capillary tube that includes a tube body that defines an internal tube volume in which the plurality of fibers is arranged, wherein the tube body includes a non-tapered section, including a first end face arranged proximate to the respective unstripped sections, and a tapered section, including a second end face, arranged around the respective stripped sections and to which the respective stripped sections are fused, wherein the tapered section tapers from a first outer tube diameter of the first end face to a second outer tube diameter of the second end face, and wherein the first end face is configured to direct backward propagating light away from the respective unstripped sections.

Aspect 2: The light combiner assembly of Aspect 1, wherein the first end face and the second end face are opposite longitudinal ends of the tube body that extend between an outer surface of the tube body and an inner surface of the tube body.

Aspect 3: The light combiner assembly of any of Aspects 1-2, wherein the second end face is coupled to an output fiber that is configured to receive the forward propagating light from the plurality of fibers and provide the backward propagating light to the capillary tube.

Aspect 4: The light combiner assembly of any of Aspects 1-3, further comprising: a high-reflective element arranged on the first end face, wherein the high-reflective element is configured to reflect the backward propagating light away from the respective unstripped sections.

Aspect 5: The light combiner assembly of Aspect 4, wherein the high-reflective element is configured to reflect the backward propagating light into a forward propagating direction.

Aspect 6: The light combiner assembly of Aspect 4, wherein the high-reflective element is a high-reflective coating configured to reflect at least 99% of light incident on the high-reflective element.

Aspect 7: The light combiner assembly of any of Aspects 1-6, wherein the first end face is an angled end face configured to internally reflect the backward propagating light such that the backward propagating light is directed away from the plurality of fibers.

Aspect 8: The light combiner assembly of Aspect 7, wherein the first end face has a specularly smooth surface to cause an internal reflection of the backward propagating light away from the plurality of fibers, wherein the internal reflection is a specular reflection at a predefined angle.

Aspect 9: The light combiner assembly of Aspect 7, wherein the first end face has a polished surface configured to prevent the backward propagating light from scattering in unwanted directions.

Aspect 10: The light combiner assembly of Aspect 7, wherein an outer surface of the tube body and the first end face are coupled at an angle that is based on a ratio of the second outer tube diameter and the first outer tube diameter.

Aspect 11: The light combiner assembly of Aspect 7, wherein an outer surface of the tube body and the first end face are coupled at an angle that is based on a ratio of a maximum numerical aperture and a refractive index of the tube body, and wherein the maximum numerical aperture is associated with the backward propagating light.

Aspect 12: The light combiner assembly of Aspect 7, wherein an outer surface of the tube body and the first end face are coupled at an angle α defined by an expression of the form:

$$α \leq {cos}^{- 1} ( \frac{1}{n} ) - \frac{N A * d}{D * n}$$

wherein n represents a refractive index of the tube body, NA represents a maximum numerical aperture associated with the backward propagating light, D represents the first outer tube diameter, and d represents the second outer tube diameter.

Aspect 13: The light combiner assembly of Aspect 7, wherein the first end face is angled away from the second end face.

Aspect 14: The light combiner assembly of any of Aspects 1-13, wherein the first end face is an angled end face configured to diffuse the backward propagating light such that the backward propagating light is directed away from the plurality of fibers.

Aspect 15: The light combiner assembly of Aspect 14, wherein the first end face has a rough surface that is configured to cause a diffuse reflection of the backward propagating light.

Aspect 16: The light combiner assembly of Aspect 14, wherein the first end face is angled toward the second end face.

Aspect 17: A method of manufacturing a light combiner assembly, the method comprising: providing a capillary tube that includes a tube body that defines an internal tube volume, wherein the tube body includes a non-tapered section, including a first end face, and a tapered section, including a second end face, wherein the first end face and the second end face are opposite longitudinal ends of the tube body that extend between an outer surface of the tube body and an inner surface of the tube body, wherein the tapered section tapers from a first outer tube diameter defined by the first end face to a second outer tube diameter defined by the second end face, and wherein the first end face is configured to direct backward propagating light in one or more directions; inserting a fiber bundle, comprising a plurality of fibers, into the internal tube volume, wherein the plurality of fibers have respective unstripped sections and respective stripped sections; and fusing the respective stripped sections to the tapered section of the capillary tube, wherein the one or more directions are directed away from the respective unstripped sections.

Aspect 18: The method of Aspect 17, further comprising: providing a high-reflective element on the first end face, wherein the high-reflective element is configured to reflect the backward propagating light away from the respective unstripped sections.

Aspect 19: The method of any of Aspects 17-18, further comprising: forming the first end face as an angled end face that is configured to internally reflect the backward propagating light such that the backward propagating light is directed away from the plurality of fibers.

Aspect 20: The method of any of Aspects 17-19, further comprising: forming the first end face as an angled end face that is configured to diffuse the backward propagating light such that the backward propagating light is directed away from the plurality of fibers.

Aspect 21: A system configured to perform one or more operations recited in one or more of Aspects 1-20.

Aspect 22: An apparatus comprising means for performing one or more operations recited in one or more of Aspects 1-20.

Aspect 23: A non-transitory computer-readable medium storing a set of instructions, the set of instructions comprising one or more instructions that, when executed by a device, cause the device to perform one or more operations recited in one or more of Aspects 1-20.

Aspect 24: A computer program product comprising instructions or code for executing one or more operations recited in one or more of Aspects 1-20.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A light combiner assembly, comprising:
a plurality of fibers that form a fiber bundle, wherein the plurality of fibers have respective unstripped sections and respective stripped sections, and wherein the plurality of fibers are configured to receive light from a plurality of respective light sources and combine the light into forward propagating light; and
a capillary tube that includes a tube body that defines an internal tube volume in which the plurality of fibers is arranged,
wherein the tube body includes a non-tapered section, including a first end face arranged proximate to the respective unstripped sections, and a tapered section, including a second end face, arranged around the respective stripped sections and to which the respective stripped sections are fused,
wherein the tapered section tapers from a first outer tube diameter of the first end face to a second outer tube diameter of the second end face, and
wherein the first end face is configured to direct backward propagating light away from the respective unstripped sections.

2. The light combiner assembly of claim 1, wherein the first end face and the second end face are opposite longitudinal ends of the tube body that extend between an outer surface of the tube body and an inner surface of the tube body.

3. The light combiner assembly of claim 1, wherein the second end face is coupled to an output fiber that is configured to receive the forward propagating light from the plurality of fibers and provide the backward propagating light to the capillary tube.

4. The light combiner assembly of claim 1, further comprising:
a high-reflective element arranged on the first end face, wherein the high-reflective element is configured to reflect the backward propagating light away from the respective unstripped sections.

5. The light combiner assembly of claim 4, wherein the high-reflective element is configured to reflect the backward propagating light into a forward propagating direction.

6. The light combiner assembly of claim 4, wherein the high-reflective element is a high-reflective coating configured to reflect at least 99% of light incident on the high-reflective element.

7. The light combiner assembly of claim 1, wherein the first end face is an angled end face configured to internally reflect the backward propagating light such that the backward propagating light is directed away from the plurality of fibers.

8. The light combiner assembly of claim 7, wherein the first end face has a specularly smooth surface to cause an internal reflection of the backward propagating light away from the plurality of fibers,
wherein the internal reflection is a specular reflection at a predefined angle.

9. The light combiner assembly of claim 7, wherein the first end face has a polished surface configured to prevent the backward propagating light from scattering in unwanted directions.

10. The light combiner assembly of claim 7, wherein an outer surface of the tube body and the first end face are coupled at an angle that is based on a ratio of the second outer tube diameter and the first outer tube diameter.

11. The light combiner assembly of claim 7, wherein an outer surface of the tube body and the first end face are coupled at an angle that is based on a ratio of a maximum numerical aperture and a refractive index of the tube body, and
wherein the maximum numerical aperture is associated with the backward propagating light.

12. The light combiner assembly of claim 7, wherein an outer surface of the tube body and the first end face are coupled at an angle α defined by an expression of the form:
α≤cos⁻¹(1/n)−NA*d/D*n in n represents a refractive index of the tube body, NA represents a D*n maximum numerical aperture associated with the backward propagating light, D represents the first outer tube diameter, and d represents the second outer tube diameter.

13. The light combiner assembly of claim 7, wherein the first end face is angled away from the second end face.

14. The light combiner assembly of claim 1, wherein the first end face is an angled end face configured to diffuse the backward propagating light such that the backward propagating light is directed away from the plurality of fibers.

15. The light combiner assembly of claim 14, wherein the first end face has a rough surface that is configured to cause a diffuse reflection of the backward propagating light.

16. The light combiner assembly of claim 14, wherein the first end face is angled toward the second end face.

17. A method of manufacturing a light combiner assembly, the method comprising:
providing a capillary tube that includes a tube body that defines an internal tube volume,
wherein the tube body includes a non-tapered section, including a first end face, and a tapered section, including a second end face,
wherein the first end face and the second end face are opposite longitudinal ends of the tube body that extend between an outer surface of the tube body and an inner surface of the tube body,
wherein the tapered section tapers from a first outer tube diameter defined by the first end face to a second outer tube diameter defined by the second end face, and
wherein the first end face is configured to direct backward propagating light in one or more directions;
inserting a fiber bundle, comprising a plurality of fibers, into the internal tube volume,
wherein the plurality of fibers have respective unstripped sections and respective stripped sections; and
fusing the respective stripped sections to the tapered section of the capillary tube,
wherein the one or more directions are directed away from the respective unstripped sections.

18. The method of claim 17, further comprising:
providing a high-reflective element on the first end face, wherein the high-reflective element is configured to reflect the backward propagating light away from the respective unstripped sections.

19. The method of claim 17, further comprising:
forming the first end face as an angled end face that is configured to internally reflect the backward propagating light such that the backward propagating light is directed away from the plurality of fibers.

20. The method of claim 17, further comprising:
forming the first end face as an angled end face that is configured to diffuse the backward propagating light such that the backward propagating light is directed away from the plurality of fibers.
